(19) United States
(12) Patent Application Publication
(10) Pub. No.: US 2005/0064852 A1
(43) Pub. Date: Mar. 24, 2005

(54) Content publishing over mobile networks

(76) Inventor: Sveinn Baldursson, Reykjavik (IS)

Correspondence Address: FISH & RICHARDSON P.C., 1425 K STREET, N.W., 11TH FLOOR, WASHINGTON, DC, 20005-3500, US

(21) Appl. No.: 10/879,528

(22) Filed: Jun. 30, 2004

Related U.S. Application Data
(63) Continuation-in-part of application No. PCT/US04/14508, filed on May 10, 2004.

(30) Foreign Application Priority Data
May 9, 2003 (IS) 6813

(51) Int. Cl. H04Q 7/20

(52) U.S. Cl. 455/414.2

(57) ABSTRACT

A system for using mobile phones for the purpose generating instant and permanent publishing of text, images and audio files as so-called “mBlogs” over mobile networks. The system allows the user to generate and publish text, attach image files and audio files with time and location of the event as a non-revocable and integral part of the published content. Users are allowed to view and interact with the published content with mobile phones over mobile networks. The system allows for sorting of content by category and by indexing the material by the operator of a mobile network and allows the users of mBlogs to search for content by category as well as by the means of indexing. Furthermore the system allows users to subscribe to mBlogs as multimedia messages for viewing on mobile phones over mobile networks.

### CROSS-REFERENCE TO RELATED APPLICATIONS

This application is a continuation-in-part under 35 U.S.C. 120 of International Application PCT/US2004/014508, with an international filing date of May 10, 2004, and titled CONTENT PUBLISHING OVER MOBILE NETWORKS. This application, through the International Application, claims priority to Iceland Application No. 6813, filed on May 9, 2003. Both the International Application and the Iceland Application are incorporated by reference.

### TECHNICAL FIELD

This description relates to systems for publishing content using mobile networks.

### BACKGROUND

Publishing by individuals is an increasingly popular area of World Wide Web content creation. Of particular interest is the rise of personal and individual diaries such as so-called “web logs” or “blogs.” These diaries are simple to use and easy to read. They are mostly text-based and have the time of release as well as the date published as integral part of the content. The strength of the “blog” is that it is instantly published and is therefore semi-synchronous in style. A limitation of the blog is that it is only available on personal computers and only edited on personal computers.

The growth of mobile phones has been rapid in the global market. Of particular interest is the recent growth of Internet and data-enabled mobile phones, whether they are 2G or 3G (i.e., 2^{nd} or 3^{rd} Generation) networks. People are increasingly mobile in their communication abilities due to the surge of mobile telephony and data capabilities of mobile phones. Peoples' behavior at work is changing as well as in their free time. More work and more leisure are possible on-line and over mobile networks.

### SUMMARY

According to one general aspect, a system includes a server operable to receive content over a mobile network from a mobile computing device operated by a first user, a time-stamping subsystem operable to assign a generation time associated with generation of the content at the mobile computing device, and a mobile data delivery platform operable to output the content and the generation time over a computer network to a second user.

Implementations may include one or more of the following features. For example, a location-stamping subsystem may be included to assign location information describing a location of the first user to the content. The server may receive a request from the second user for time-specified content, and output the time-specified content to the second user using the time-stamping subsystem.

The mobile data delivery platform may be operable to deliver the content to a mobile phone of the second user, and the server may be operable to store subscription information for the second user, and further operable to forward the content to the second user over the mobile phone, based on the subscription information.

The server may be operable to receive secondary content from the second user and associate the secondary content to the content. The server may be operable to sort and index the content relative to existing content or categories, and further operable to provide searching of the content based on the sorting and indexing thereof.

The content may include text, image information, audio information, or numerical information. The location-stamping subsystem may obtain the location information for the first user from cell positioning information obtained from the mobile network, or by using a location based server or a global positioning system. The server may be operable to permanently store the content.

The server may be further operable to deliver the content to a pre-defined group of recipients, the group including the second user, to receive a comment on the content from the second user, and to modify the content with the comment for re-distribution to the group, including the first user. A media server may be operable to receive a request from the server for a digital image, and further operable to transcode the digital image to an acceptable format for physical printing thereof.

A database may be used for storing the content, where the content includes a first collection of digital images or audio and a second collection of digital images or audio, and where the first collection is associated with a first access level and the second collection is associated with a second access level. A remote server may be included that is remote from the server, where the server may be operable to forward the content to the remote server for distribution to multiple servers at geographically dispersed locations.

The server may be operable to determine that the first user is not a registered user, and may be further operable to automatically generate a user profile for the first user, based on information received within the content. The server may be operable to associate a ratings portion with the content for outputting to the second user, and may be further operable to compile rating information received from the second user using the ratings portion with additional rating information previously received from other users.

A media server may be included that is operable to transcode digital image information included within the content for display based on a defined type of mobile device being used by the second user as received from the server, where the server may determine the defined type of mobile device used by the second user based on a request from the second user. The server may output the content to a first service provider associated with the second user for outputting to the second user, and may further output the content to a second service provider associated with a third user for outputting to the third user.

According to another general aspect, content entered into a mobile device by a user of the mobile device is received, via a network on which the mobile device operates. A blog file associated with the user is determined, the content is included within the blog file, and the blog file, including the content, is made available to other users of the network.

Implementations may include one or more of the following features. For example, in receiving content from the user, location information defining a location of the user at a time the content was entered into the mobile device may be determined, and the location information may be associated with the content.

In receiving content from the user, time information defining a time at which the user entered the content into the mobile device may be determined, and the time information may be associated with the content. The content may include digital image or audio information.

In making the blog file available, subscribed users may be determined from among the other users who have previously requested a subscription to the blog file, and the blog file may be distributed to the subscribed users.

Making the blog file available may include publishing the blog file to the public Internet, or outputting the blog file to a first and second service provider, where, in the latter case, the other users may include users of the first service provider as well as users of the second service provider.

A comment may be received from one of the other users in reply to the blog file, the comment may be associated with the blog file, and the blog file, including the comment, may be output to the other users, including the user.

A system is described that allows users to instantly generate permanent text content from a mobile phone (“mBlogs”) as time sensitive log files, or “blogs” generated over a mobile network. The system may allow users to view permanent and instantly-generated mBlog content from a mobile phone, or from a personal computer.

The system may allow users to interact and publish permanent and instantly-generated comments linked to the mBlogs. Categorization and indexing of the mBlogs may be performed for the purpose of facilitating search and matching of viewers or writers of mBlogs.

Images, audio, and/or numerical content may be included in addition to the published text content. Users may subscribe to mBlogs over a mobile network using a mobile phone. Users may be able to log on to a specific time that has already past, and access existing content published at the specified time. Also, Users may log onto a specific time and access current content published outside of the mBlog format, such as 3rd party databases published at the specified time, including images, weather, market and news information for a multimedia “Time Capsule” experience of a user logging on an existing mBlog.

The details of one or more implementations are set forth in the accompanying drawings and the description below. Other features will be apparent from the description and drawings, and from the claims.

### DESCRIPTION OF DRAWINGS

FIG. 1 is a block diagram of the basic interaction of the users of a mobile blog (mBlog) system, where User (A) and User (B) are connected to a mobile network with mobile phones.

FIG. 2 is a block diagram showing two users connected to an mBlog server, where User (A) is connected over a mobile network, but User (B) is viewing mBlog content on a personal computer connected to any IP network.

FIG. 3a is a block diagram showing User (B) submitting a query to an mBlog server.

FIG. 3b is a block diagram showing query results submitted from an mBlog server to the user.

FIG. 4 is a block diagram showing User (B) inserting permanent comments.

FIG. 5 is a block diagram showing User (A) submitting and User (B) downloading an image.

FIG. 6 is a block diagram showing User (A) submitting and User (B) downloading audio.

FIG. 7 is a block diagram showing User (A) submitting and User (B) downloading numerical content.

FIG. 8a is a block diagram showing User (B) submitting a request for subscription of mBlogs

FIG. 8b is a block diagram showing User (B) receiving a subscribed mBlog message.

FIG. 9 is a block diagram of an implementation of a mobile blog (mBlog) system.

FIG. 10 is a block diagram of a process flow illustrating a group blogging implementation of the system of FIG. 9.

FIG. 11 is a block diagram of a process flow illustrating a photo-printing implementation of the system of FIG. 9.

FIG. 12 is a block diagram of photo albums created using the system of FIG. 9.

FIGS. 13 and 14 are block diagrams of a world-wide implementation of the system of FIG. 9.

FIG. 15 is a block diagram of a process flow illustrating use of the system of FIG. 9 by a non-registered user.

FIG. 16 is a block diagram of an implementation of the system of FIG. 9 that include mBlog ratings.

FIG. 17 is a block diagram of an implementation of the system of FIG. 9 designed for mobile commenting.

FIG. 18 is a block diagram of a process flow illustrating an image transcoding implementation of the system of FIG. 9.

FIG. 19 is a block diagram of the system of FIG. 9 operating with multiple mobile operators.

### DETAILED DESCRIPTION

The mBlog invention relates to a system that enables the real-time, location-based generation of permanently published content on data-enabled mobile phones, via mobile networks. The invention enables users of data-enabled mobile phones to write text, insert images and other digital content, and upload such content to data servers available over mobile networks on mobile phones and on personal computers over the Internet. The system detects, generates, and publishes data confirming the location and time of the user when the published content is submitted to the server. The location data is extracted by the system from the mobile network, either directly from the cell network or with assisted advanced location tracking. The invention allows other users to view, download, subscribe to, and interact with the published content using a mobile phone.

The invention allows users to create and publish content that has before been limited to fixed line computers, in particular personal computers, whereby the power of instant diaries on-line, or blogs has been limited to such settings. In contrast, the invention makes use of the power of mobile, data-enabled phones for generating and viewing blogs. Furthermore, the invention allows for blogs generated by a mobile phone to be viewed on-line by users of personal computers, thus making the most of both market segments. The “mobile blog” can revolutionize the way people generate blogs, as they are no longer confined to publishing on personal computers, and are only limited by the coverage of data-enabled mobile networks.

mBlog allows using the location of the user as a permanent part of the published content. This is done by using the data available from the mobile network, either the cell positioning data or by enhanced location data generated with location based servers and/or global positioning systems. The mBlog system uses mobile subscription delivery for unique real-time reception of mBlog content via multimedia messaging (MMS), WAP push, or Session Initiation Protocol (SIP). This utilizes the essential features of mobility harnessed with the mBlog invention, both on the receiving end, as well as on the authoring/publishing end.

In other words, the invention is made to facilitate the creation and viewing of “personal diaries” by harnessing the power of mobile networks and mobile phones. The invention is based on a system for instant and permanent publishing of text, images and audio content over mobile networks. The system allows the user of the invention to write text, attach image and audio files, and publish those by using a mobile phone and without the use of a personal computer.

The system allows the published content to be downloaded by other users by mobile phones over mobile networks. No other computer apparatus is needed for the generation, subscription, searching or viewing of the content than existing mobile networks and the mBlog system.

The published files are permanent and certified as such by the system. This information is stored on computer servers with the published content for the lifetime of the system. The published files can be viewed by any mobile terminal allowing for text, image or audio download, viewing, reading, or listening on any known current and future mobile delivery platform.

The operator of the mobile network can limit the access of the published content by means of tarriffing and by creating specific subscriptions for the service of writing, viewing, and adding to the published content. To particular interest of the invention is the capability of offering multimedia subscription where the mBlog content is sent (pushed) to the subscriber in short messaging (SMS) as well as multimedia messaging format (MMS).

The system creates an automatic and permanent “time-stamp,” where the publishing time is a permanent and non-erasable part of the published file. The system allows automatic and permanent “location-stamp,” where the current user location is a permanent and non-erasable part of the published file. The system allows publishing of visual representation of the user location, i.e., maps showing where the user is publishing the published content at a given time.

The system allows users to subscribe to published content from other users, i.e., by multimedia messaging (MMS) using the mBlog server 108 as well as MMS servers. This enables users to receive multimedia messages including images, audio as well as text. Furthermore this enables users to receive messages as soon as they are created, making the messaging more synchronous.

The published files can be categorized and indexed according to content. When the numbers of mBlogs are increasing, the categorization of the content becomes valuable for publishers and viewers alike. Mobile Network Operator (MNO) or its assignees can maintain the categorization according to the set-up made by the MNO. This allows users to find material of interest, and mBlog creators to reach a more receptive audience.

Indexing of content allows users to file and search for individual files, content, authors, by time, location and relevance. The indexing is defined by the set up of the mBlog server 108 using a match list of preferred parameters and values.

The mBlog system allows the users to search by categories as well as by indexed context. With the growth of more and more mBlogs, categorization makes for a better usability, as users can better find the content they seek through such categorization.

Users can register individual mBlog content files in categorized mBlog communities. Network operator or individual users define these categories in a hierarchical manner depending on the set-up defined by the MNO.

Viewers of mBlogs can interact with user-generated content by publishing comments that are directly linked with the mBlog content. This allows viewers to add information as well as opinions that are related to the subject of an mBlog.

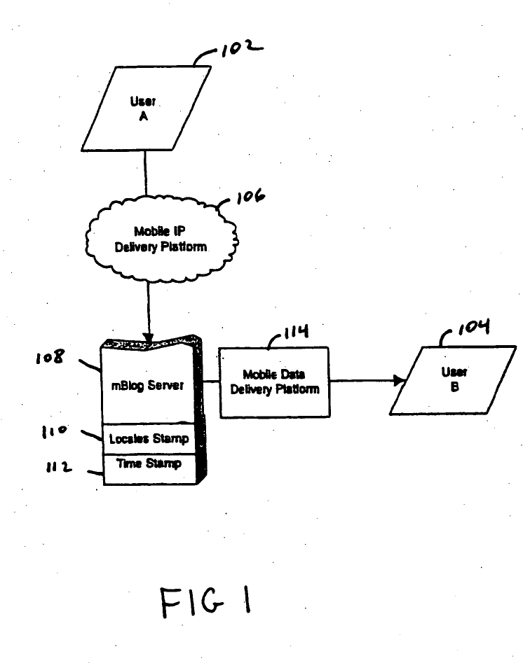

FIG. 1 is a block diagram of the basic interaction of the users of the system, where User (A) 102 and User (B) 104 are connected to a mobile network 106 with mobile phones. Specifically, in FIG. 1, User (A) 102 is generating an mBlog and user (B) 104 is viewing the mBlog on a mobile phone over the mobile network 106.

The user (A) 102 can create a mBlog content using the mobile phone when using the mBlog application. As a subscriber to the mBlog service the user (A) 102 can easily generate text content on the mobile phone. The user (A) 102 accesses an allocated mBlog editing area by selecting “my Blog” from the mobile phone. From there the user (A) 102 can type in text content using the numerical keyboard on the mobile phone, in the same way as when typing small text messages (SMS).

When satisfied with the text content, the mBlog creator can post the text content as mBlog message on the network with one-click confirmation. The text may be location-stamped and/or time-stamped by an mBlog server 108, using a location stamping subsystem 110 and a time-stamping subsystem 112, respectively, and published over the Internet on the World Wide Web, Wireless Application Protocol (WAP), and pushed to subscribers of mBlog multimedia service (MMS).

Other users (B) can view the text content on other mobile phones using the mBlog application, as delivered by a mobile data delivery platform 114 making use of the protocols/services just discussed. The content published by the user (A) 102 can be viewed essentially instantaneously after the submitting over the network. As just discussed, the content may contain time of publishing, and may contain location information (“location stamp”), as permanent part of the published text.

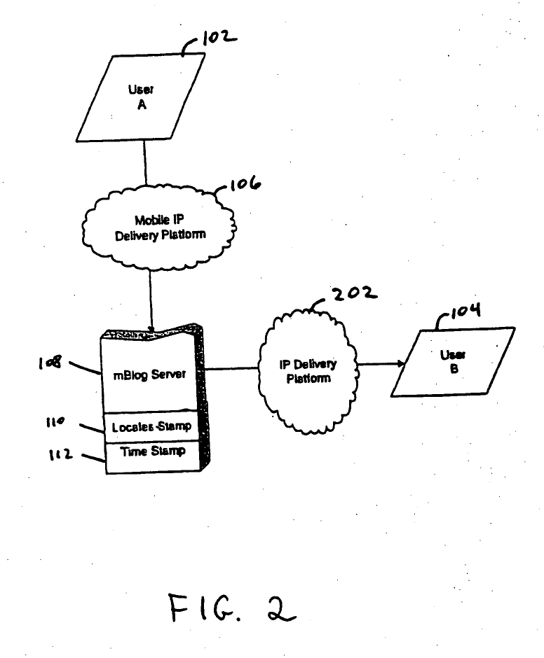

FIG. 2 is a block diagram showing two users connected to an mBlog server, where User A is connected over a mobile network 106, but User B is viewing mBlog content on a personal computer connected to any IP network (represented by an IP network 202).

Users connected to the World Wide Web by the means of a personal computer (User B) can view text content published by mBlog content publishers (User A). As in FIG. 1, the user (B) 104 can download and read the published content immediately after submitting of the content by the issuer (A).

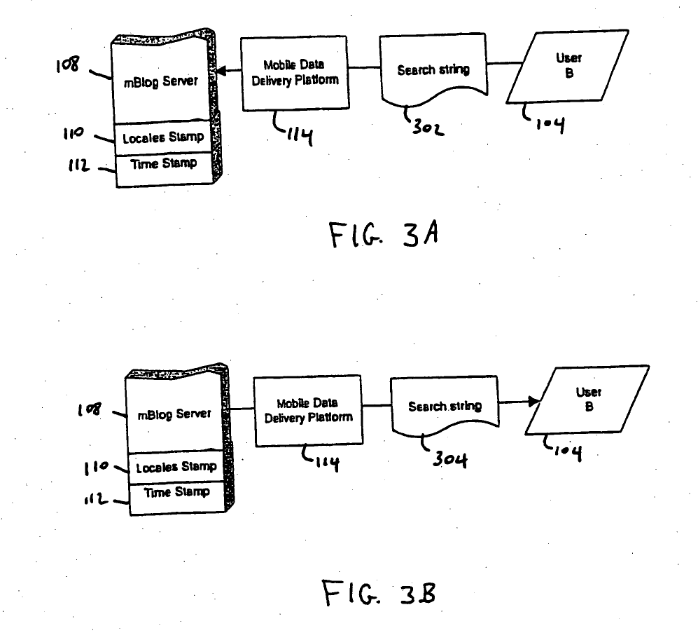

FIG. 3a is a block diagram showing User (B) 104 submitting a query or search string 302 to the mBlog server 108. Specifically, User (B) 104 is submitting a query for mBlog messages by context on a mobile phone over a mobile network 106/mobile delivery platform 114.

Users can search for a specific mBlog, by individual words, combination of words, fragments, and phrases. The search string is submitted over the network by a user of a mobile phone or personal computer to the mBlog server. FIG. 3b is a block diagram showing query results 304 submitted from an mBlog server 108 to the user, in which the server performs a query and pushes the results to the User (B) 104 over the network.

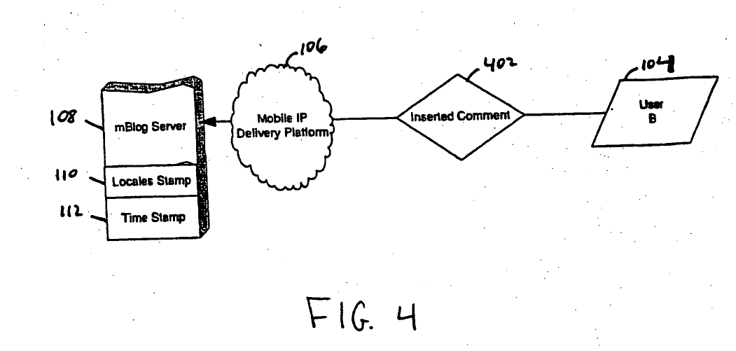

FIG. 4 is a block diagram showing User (B) 104 inserting permanent comments 402. Specifically, FIG. 4 illustrates User (B) 104 inserting permanent comments 402 linked to mBlog content that is generated by User (A) 102. Thus, as shown, users can write and publish (insert) comments on the mBlog text content.

This is facilitated, for example, by a command “add comments” issued as part of the published content. By selecting this command, the User (B) 104 can post text comments that can be viewed by other users. As in the case of the original mBlog text, the “comments” contain the time of issue as a permanent part of the published content.

Users can download and read the published comments by means, for example, of a command “view comments” issued as part of the published content. When selected, the “view comments” command opens a new window with all relevant comments listed in order of publishing time.

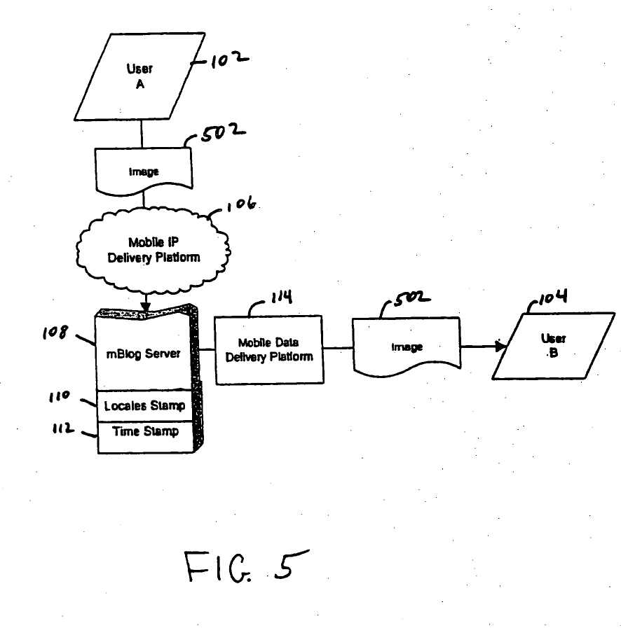

FIG. 5 is a block diagram showing User (A) 102 submitting and User (B) 104 downloading an image 502. More specifically, FIG. 5 illustrates User (A) 102 generating mBlog content containing an image 502 and User (B) 104 viewing the image 502 on a mobile phone over a mobile network 106.

As shown, a creator of an mBlog (User A) can post (upload) an image as part of the published mBlog. The image 502 becomes an integral part of the text content, available for viewing by terminals that support viewing of graphical images. Any user of the mBlog application, either using a mobile network 106 or any computer network, is able to access the images as part of mBlog content.

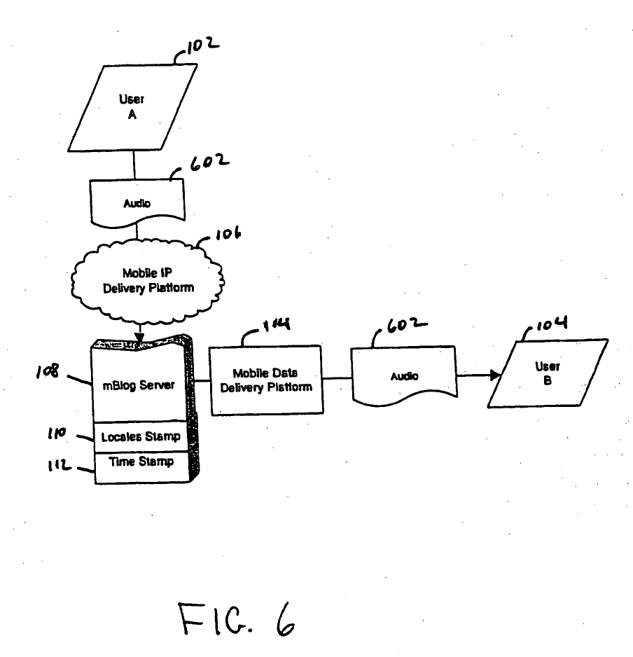

FIG. 6 is a block diagram showing User (A) 102 submitting and User (B) 104 downloading audio 602, where User (B) 104 is accessing the audio on a mobile phone over mobile network 106. A shown, a creator of an mBlog (User A) can post (upload) an audio file 602 as part of the published mBlog. The audio file 602 becomes an integral part of the text content, available for playback by terminals that support playback of audio. Any user of the mBlog application, either using a mobile network 106 or any computer network is able to access the audio as part of mBlog content.

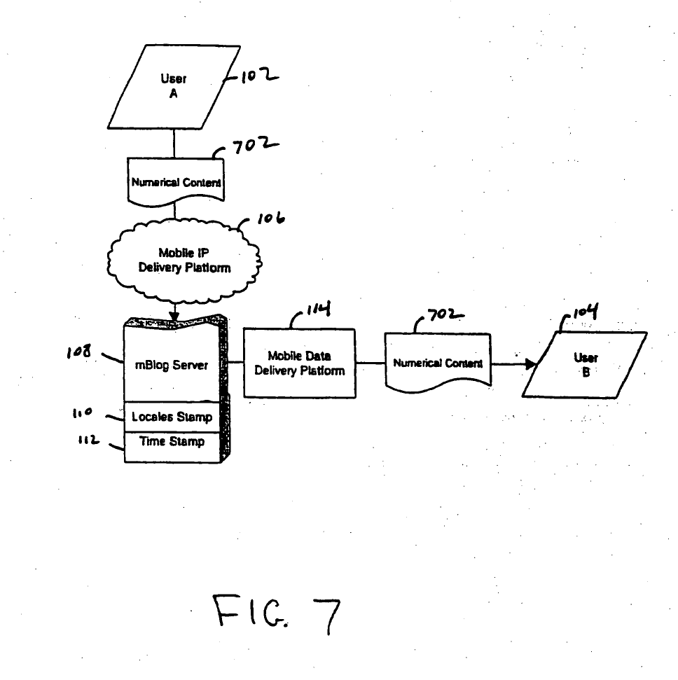

FIG. 7 is a block diagram showing User (A) 102 submitting and User (B) 104 downloading numerical content 702, on a mobile phone, over a mobile network 106. As shown, a creator of an mBlog (User A) can post (upload) a numerical content file 702 as part of the published mBlog. Any user of the mBlog application, either using a mobile network 106 or any computer network is able to access the numerical content file 702 part of mBlog content.

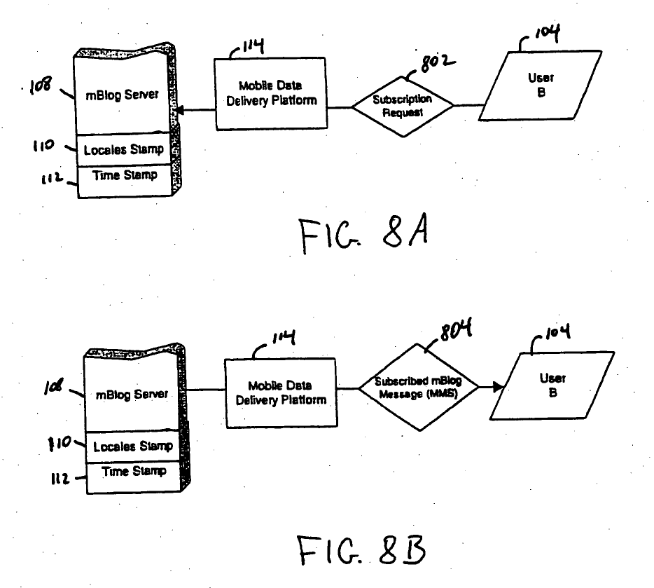

FIG. 8a is a block diagram showing User (B) 104 submitting a request 802 for subscription of mBlogs on a mobile phone, over a mobile network 106. FIG. 8b is a block diagram showing User (B) 104 receiving a subscribed mBlog message 804 on a mobile phone, over a mobile network 106.

As shown, users can subscribe to specific mBlog content. The User (B) 104 subscribes by submitting a subscription request 802 over the mobile network 106 to the mBlog server. The mBlog server 108 lists the respective mBlog subscribers to the subscribers list of that particular mBlog, and compiles a message 804 to each of the subscribers from the mBlog content. The message 804 is sent to the mBlog subscribers in multimedia format with all the mBlog components, such as text, images, audio or numerical files. The user (B) 104 receives the mBlog in Multimedia Messaging Service (MMS), or similar, over the mobile network 106.

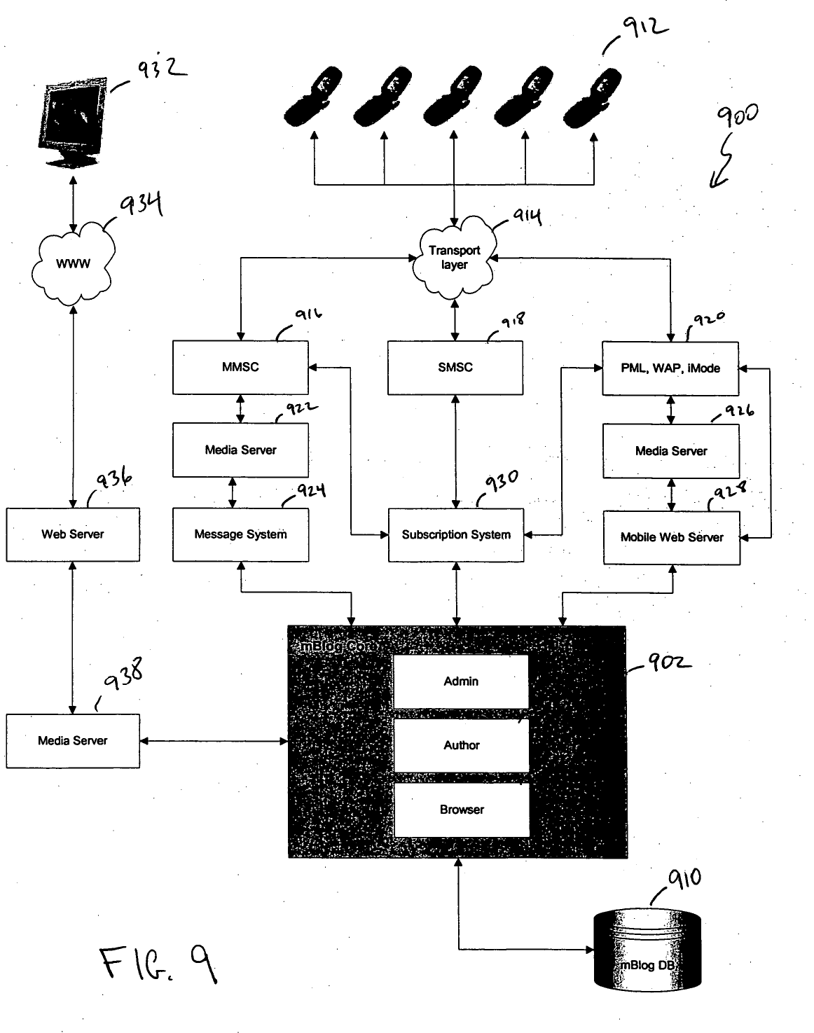

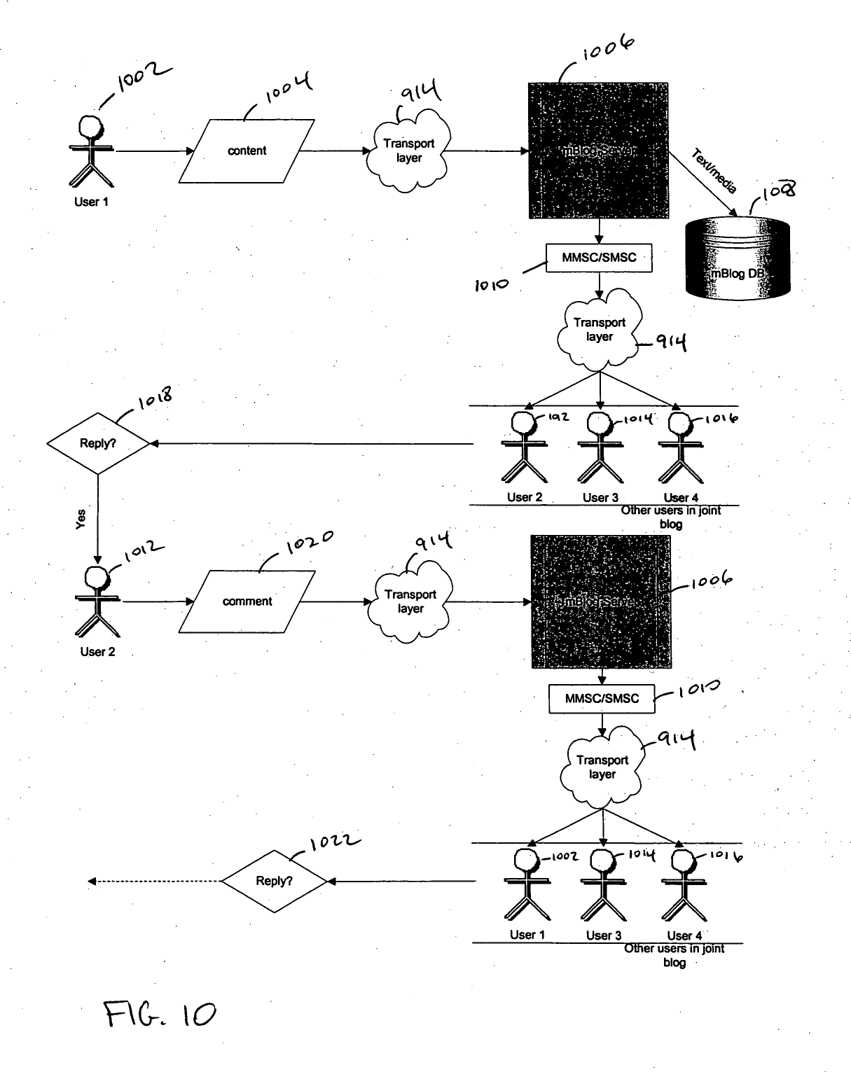

FIG. 9 is a block diagram of an implementation of a mobile blog (mBlog) system 900. A descriptive overview of the mBlog system 900 is provided below with respect to FIG. 9, and various features, uses, variations, and implementations of the mBlog system 900 are further discussed with respect to FIGS. 10-19.

In FIG. 9, an mBlog server core 902 provides an administration system 904, an authoring system 906, and a browser 908. The admin system 904 is generally responsible for enabling management of the various functionalities of mBlog services. Examples of such services are discussed in detail below, but generally include subscription services, access levels of specific users with respect to particular services, and user registration functions.

The authoring system 906 serves, for example, to receive content from a publishing user in a particular format, and to format or otherwise modify the content for publishing over the network as a blog. It should be understood that the authoring system 906 also may include features discussed above with respect to FIG. 1. For example, the authoring system 906 may include functionality for determining and associating a location of the publishing user with the blog entry, or for associating a time when the content was published.

The browser 908 represents web-based administration of the mBlog system 900. For example, a service provider may access the mBlog system 900 in order to change users' access levels, or to modify or add services to the mBlog system 900. In one implementation, a web based administration subsystem may be used with the browser 908 for managing and monitoring the mBlog system 900.

Additionally, the browser 908 may represent the use of an mBlog portal provided by an operator of the system 900 or by a mobile service provider. For example, such an mBlog portal may be provided as a common starting point for viewers and creators of mBlogs to access mBlogs and their contents. Further, such a portal may allow users to search existing mBlogs, to categorize their access to mBlogs, or to otherwise personalize their use of the system 900.

An mBlog database 910 is generally responsible for storing information associated with operation of the mBlog system 900. Of course, various (types of) databases and other memories may be used, depending on the quantity and type of information to be stored. Examples of information stored in the database 910 include the content to be published (including associated comments, location information, and time information regarding the content), user registration information, and various other data associated with providing the various functionalities described herein.

In practice, and similarly to the mBlog system of FIG. 1, the mBlog system 900 may receive content from a user of a mobile device, represented in FIG. 9 by mobile devices 912. The content is provided via a transport layer 914, which may represent, for example, communication over a network of a mobile services provider, or over the Internet.

The content may initially be received at a number of messaging centers, gateways, or other content delivery and routing systems, including a Multimedia Messaging Service Center (MMSC) 916, a Short Message Service Center (SMSC) 918, or using other platforms and/or techniques represented by a message center 920 that include support for Wireless Application Protocol (WAP), Partner Markup Language (PML), and/or iMode.

The MMSC 916 generally allows users 912 to send and receive messages with media elements including text, image, video, and sound, as described above with respect to FIGS. 5 and 6. A media server 922 sits behind the MMSC 916 to support transmission of the image, video and/or sound over the network. The media server 922 interacts with a message system 924, which, in turn, interacts with the mBlog core 902 in order to route messages appropriately between the users 912.

The SMSC 918 allows for the transmission of short text messages to and from devices including a mobile phone and/or IP address. An example of a functionality of the SMSC 918 is discussed and shown above with respect to FIG. 7. Generally, then, the SMSC 918 enables messages of a pre-determined length of alpha-numeric characters that do not contain images or other graphics.

The center 920 similarly receives content from the users 912 using any of the identified platforms and protocols. For example, WAP enables the users 912 to access information using various types of handheld wireless devices, including, for example, mobile phones, pagers, two-way radios, smartphones and communicators. WAP supports both the Wireless Markup Language (WML) and xHTML, where these represent XML standard(s) designed for small screens, limited bandwidth, and one-hand navigation, without a (full) keyboard being needed.

Somewhat similarly, the center 920 interacts with a media server 926, and/or with a mobile web server 928, the latter of which communicates with the mBlog core 902. In this way, a wide range of data delivery platforms may be supported for operators, including, as further examples to those already mentioned, Java 2 Micro Edition (J2ME), color-WAP, Sim Tool Kit, Brew, SmartPhone, and Symbian. This multi-channel approach allows the mBlog system 900 to be implemented in conjunction with multiple operators and mobile service providers to provide graphics, audio, location data, touch screens and memory.

For example, the mBlog application may be provided across service providers, such as, for example, Verizon, AT&T, Nextel, and others, even considering that providers often employ different brands and types of mobile devices, where the mobile devices may themselves be using a wide variety of applications, platforms, and operating systems. Moreover, mBlog may be implemented globally, and is inter-operable with United States, European, and Asian operators and providers. As a result, each of the users 912 may share content using the mBlog system, without regard to the provider, device, and operating environment of the other users 912.

A subscription service 930 communicates with the MMSC 916, the SMSC, 918, and the center 920, as well as with the mBlog core 902. The subscription service 930 enables the provision of premium access to particular mBlogs. For example, a particular mBlog, perhaps of a celebrity or other famous individual, may be made available to the users 912 on a premium basis, so that only those users paying for access will be able to view the particular mBlog.

As just described, each of the mobile users 912 may create and upload blog content from their respective mobile devices, for essentially simultaneous and instantaneous viewing and use by others of the mobile users 912. Additionally, as described above with respect to FIG. 2, a user 932 of the public Internet or world-wide web (WWW) 934 also may post blog entries and/or view blogs created by the mobile users 912.

In particular, the user 932 may access a web server 936 and, if necessary to include photographs, video, or audio, a media server 938. In this way, a user may create and view mBlogs using a mobile device, but also may perform the same functionality from virtually any Internet-connected computer.

FIG. 10 is a block diagram of a process flow illustrating a group blogging implementation of the system 900 of FIG. 9. Group blogging refers to an ability of one of the users 912 to share a mBlog with selected ones of their friends or colleagues, and to increase and facilitate interaction between the friends or colleagues.

In FIG. 10, a user 1002 uploads content 1004 via the transport layer 914 and using an available protocol (e.g., MMS or SMS), to an mBlog server 1006. The mBlog server 1006 may include, for example, a functionality of the mBlog server core 902 of FIG. 9, or the mBlog server 108 of FIG. 1.

As already described, the content 1004 may be location and time-stamped, and then permanently stored within a database 1008, such as the database 910 of FIG. 9. Additionally, the mBlog server 1006 may then forward the content 1004 back over the transport layer 918, using a delivery center 1010 that may include, for example, the MMSC 916 or the SMSC 918. Specifically, the mBlog server 1006 and/or the database 1008 may store a pre-defined group of users who are designated to automatically receive all updates to the mBlog of the user 1002.

As a result, users 1012, 1014, and 1016 all receive the mBlog of the user 1002, or the specific content 1004. For example, the content 1004 may be forwarded to an e-mail account of some or all of the users 1012, 1014, and 1016. As another example, a link to the mBlog may be sent to the e-mail accounts of the users 1012, 1014, and 1016.

In this way, a receiving user, such as the user 1012, may wish to reply to the message regarding the new content 1004. For example, the user 1012 may user a reply button on a handset of his or her mobile device to then enter text, provide a picture using an associated camera, or record a voice message.

If a reply is sent (1018), it may be in the form of a comment 1020 regarding the content 1004. The comment 1020 is forwarded over the transport layer 914 to the mBlog server 1006, which determines the associated mBlog and associates the comment therewith. For example, a parameter in a subject or header of the comment may be used by the server 1006 to identify the relevant mBlog.

From the mBlog server 1006, the comment (or link to the mBlog, which may now contain the comment) is forwarded back over the delivery center 1010 and the transport layer 914 to all of the other users 1002, 1014, and 1016 within the group. If one of these members would like to reply (1022) to the comment 1020, then the process continues.

In one implementation, the users 1002, 1012, 1014, and/or 1016 may each choose to register to receive mBlog updates from one another. In another implementations, the user 1002 may start the mBlog and extend invitations to the others to join the group to automatically receive updates.

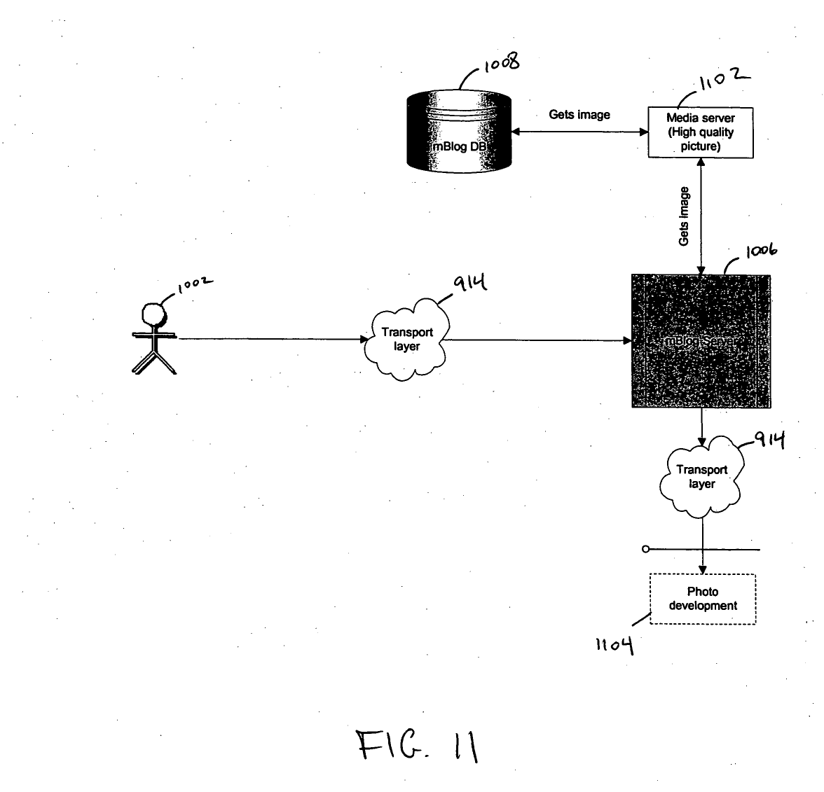

FIG. 11 is a block diagram of a process flow illustrating a photo-printing implementation of the system 900 of FIG. 9. In the implementation of FIG. 11, the user 1002 is provided with a hard-copy of an image that was previously posted to the mBlog system 900.

In FIG. 11, the user 1002 connects to the mBlog system 900. For example, the user 1002 may connect to an mBlog portal on the mBlog server 1006, by accessing the transport layer 914 to use either a web browser or another mBlog-enabled client. The mBlog server 1006 provides an available selection of photographs and collects images chosen by the user 1002.

The photographs or other images are obtained from the database 1008 and sent through a media server 1102 that transcodes the images to a highest-quality format that is available. Then, the server 1006 forwards the images over the transport layer 914 to a photo development environment 1104.

For example, a photo developer may provide an interface for receiving digital images, so that the mBlog server 1006 may access the interface to provide the selected images, along with information regarding the user 1002. In this way, the action required by the user 1002 to obtain the hard copy of the photograph is minimized, and the user 1002 may easily and conveniently obtain mBlog photographs.

It should be understood that the accessed images could be originally posted by the user 1002, or by other users. For example, the user 1002 may be traveling with a camera phone, and may wish to upload a number of pictures to an mBlog. Later, the user 1002 may wish to select one or more of the pictures for printing. As another example, the user 1002 may simply be viewing mBlogs of other users, and may select a photograph from one of the users' mBlogs for printing. The printed photographs may then be delivered to an address that has been pre-specified by the user 1002.

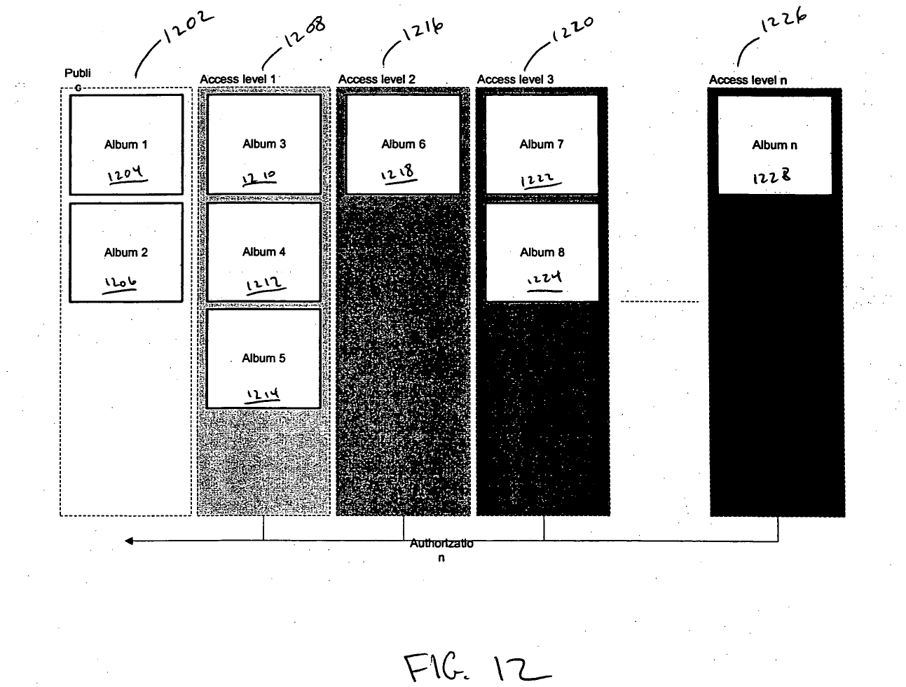

FIG. 12 is a block diagram of photo albums created using the system 900 of FIG. 9. In FIG. 9, the user 1002 has created a number of photo albums, by grouping together designated photographs that have been obtained and posted to the user's mBlog(s).

More particularly, the photo albums are posted to the mBlog(s) such that a publicly-available album group 1202 includes albums 1204 and 1206. Meanwhile, a number of private access levels also may be provided. Specifically, a first access level 1208 includes albums 1210, 1212, and 1214, a second access level 1216 includes an album 1218, and a third access level 1220 includes albums 1222, and 1224, and, finally, an nth access level 1226 includes an album 1228.

In one implementation, each access level is associated with a password that the user 1002 may distribute as desired. For example, the user 1002 may provide a specific password to work colleagues to view photographs from a company event, while providing a second password to family members who may wish to view private family photos.

In one implementation, the access levels 1208, 1216, 1220, and 1226 may be chained such that a user having a certain level of access may view all albums at or below that level of access. As shown, multiple albums may be created within each access level.

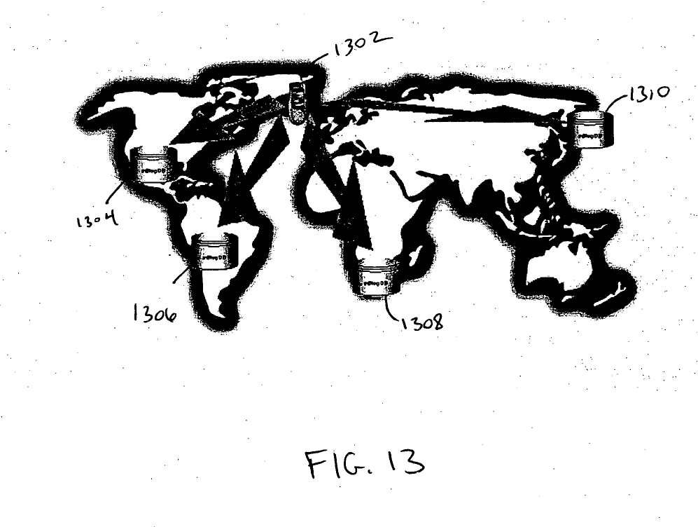

FIG. 13 is a block diagram of a regional up to world-wide implementation of the system 900 of FIG. 9. In FIG. 13, a mobile device 1302 uploads content that is ultimately shared between servers 1304, 1306, 1308, and 1310, which are distributed around the world.

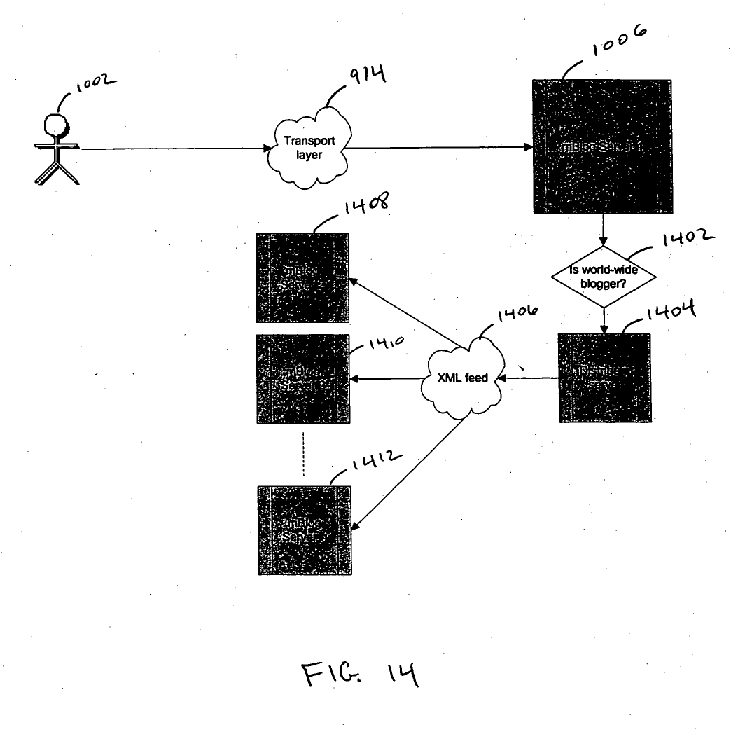

More specifically, as shown in FIG. 14, the user 1002 may use the mobile device 1302 to upload content over the transport layer 914 to the mBlog server 1006, as already described. The server 1006 may provide an mBlog portal for users as described above, where this portal may generally be accessible, at least for practical purposes, to users within a geographic region or area. As a result, users in different areas of a region, or of the world, may access different mBlog portals, where each portal is associated with a particular server(s).

In this case, the mBlog server 1006 may access a database or other user profile information to determine whether the user 1002 is classified as a regional or a world-wide blogger (1402). If so, the mBlog server 1006 forwards the content to a distribution server 1404, which encodes the content within an XML feed 1406, or uses some other technique, to forward the content to servers 1408, 1410, and 1412 (conceptually corresponding to the servers 1304, 1306, 1308, and 1310 of FIG. 13). In this way, the content is viewable from the mBlog portal of each of the servers.

In one implementation, each of the servers 1408, 1410, and 1412 (in addition to the server 1006) contains its own copy of the original content. In this case, the additional copies may also be used to provide back-up versions of the content.

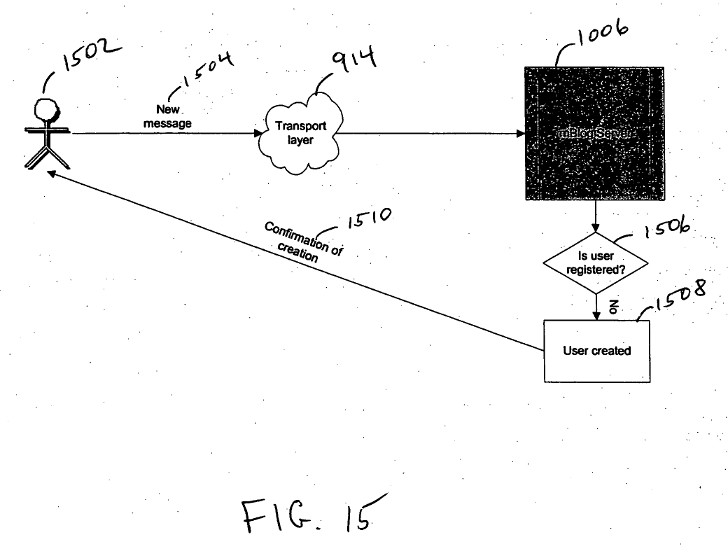

FIG. 15 is a block diagram of a process flow illustrating use of the system 900 of FIG. 9 by a non-registered user 1502. In FIG. 15, the user 1502 sends a new message 1504 over the transport layer 914 to the mBlog server 1006.

The mBlog server 1006 receives the message 1504 and determines whether the user 1502 is registered (1506). If not, the mBlog server 1006 creates a new user profile (1508), and then sends a confirmation 1510 to the user 1502. The confirmation 1510 may include temporary login information which the user 1502 may use or discard, or which the user 1502 may edit to better reflect the user's desired profile information.

In one implementation, the mBlog server 1006 receives the message 1504 and automatically checks to see if the Mobile Station ISDN Number (MSISDN), which is the standard international telephone number used to identify a user, is registered. If not, a new user profile is created, and login details are forwarded to the user 1502 as the confirmation 1510.

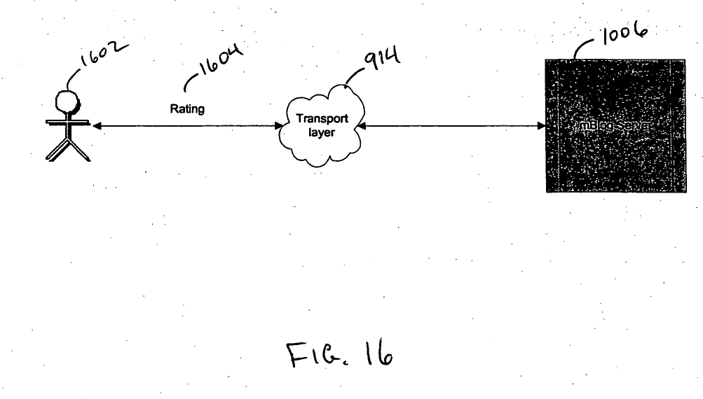

FIG. 16 is a block diagram of an implementation of the system 900 of FIG. 9 that include mBlog ratings. In FIG. 16, a user 1602 viewing an mBlog may rate the mBlog, for example, on a scale of one to ten, by submitting a rating 1604 over the transport layer 914 to the mBlog server 1006. Upon sending the rating, the user 1602 may be allowed to view a cumulative rating of the mBlog, reflecting ratings submitted by other users.

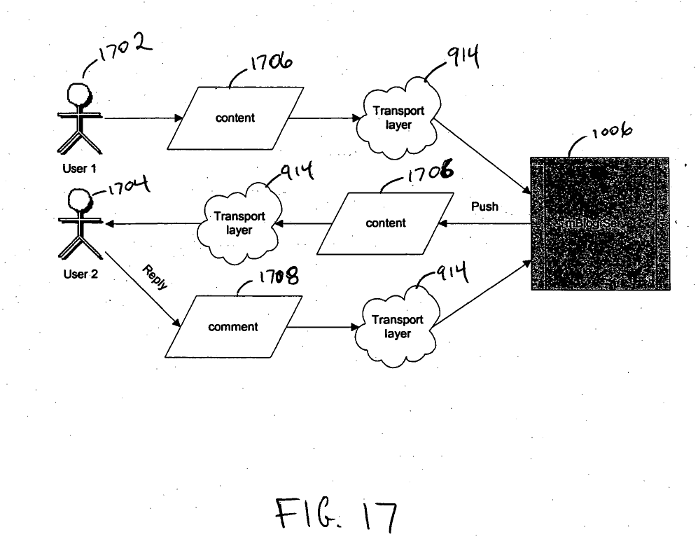

FIG. 17 is a block diagram of an implementation of the system 900 of FIG. 9 designed for mobile commenting. In FIG. 17, users 1702 and 1704 are registered with the mBlog system 900. The user 1702 uploads content 1706 over the transport layer 914 to the mBlog server 1006.

The mBlog server 1006 reviews its database(s) for subscribers to the mBlog of the user 1702, and determines that the user 1704 is a subscriber. The mBlog server 1006 then pushes the content 1706 to the user 1704, perhaps using the push functionality associated with WAP, MMS, or SMS. The user 1704 reviews the content 1706 and hits a reply button on his or her mobile device to send a comment 1708 back over the transport layer 914 to the mBlog server 1006. In this way, the user 1704 may become aware of, and easily comment on, the mBlog of the user 1702.

The reply message may contain information in its header or subject field that identifies the mBlog to which the user 1704 is responding. Then, the mBlog server 1006 may forward the reply comment from the user 1704 back to the original user 1702.

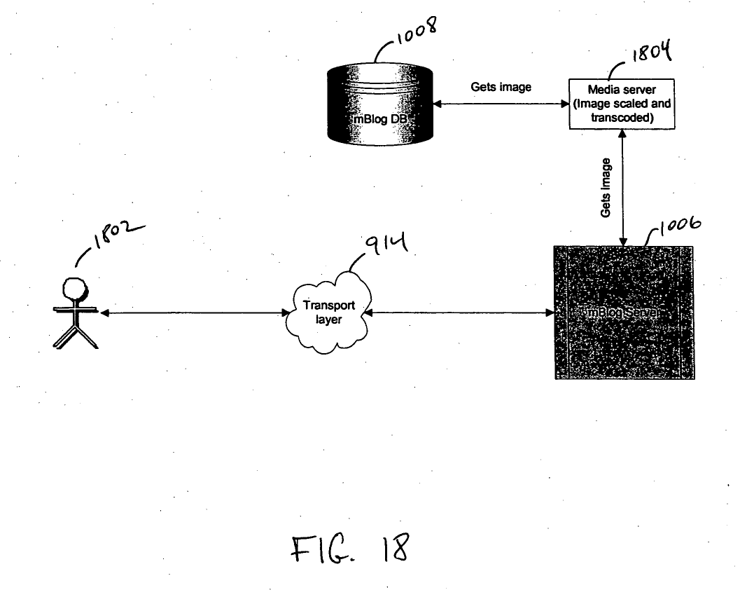

FIG. 18 is a block diagram of a process flow illustrating an image transcoding implementation of the system 900 of FIG. 9. Specifically, FIG. 18 illustrates techniques for scaling and transcoding images for rendering on the various types of handsets of users, which may have widely-varying features, such as display resolution, available formats, or downloading abilities.

In FIG. 18, a user 1802 requests content from the mBlog server 1006 using the transport layer 914, where the content includes an image. The request from the user 1802 includes a header that is referred to as the “user-agent” header, which may be used to identify a type of handset used by the user 1802.

This type, along with the image itself, is forwarded to a media server 1804, which obtains the image from the database 1008 and uses the type information to scale and transcode the image. Thereafter, the mBlog server 1006 may provide the image to the user 1802 using a scale, format, and resolution that is particularly suited to the handset being used by the user 1802.

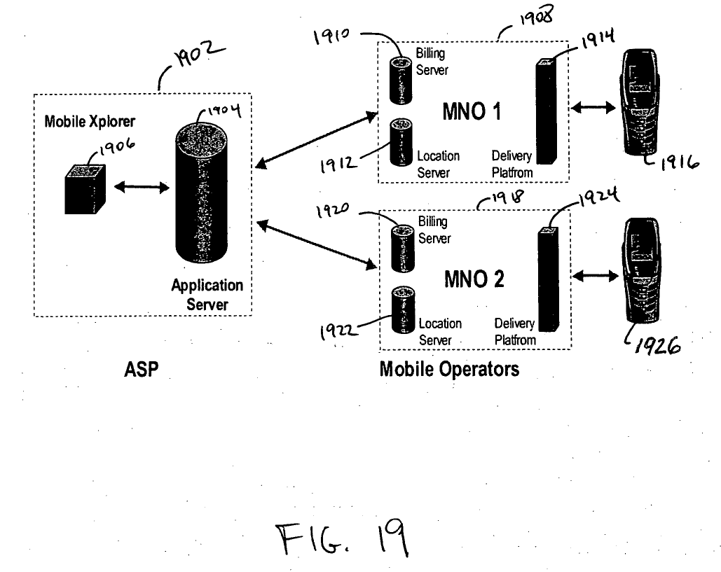

FIG. 19 is a block diagram of the system 900 of FIG. 9 operating with multiple mobile operators. In FIG. 19, an application service provider (ASP) 1902 includes an application server 1904 (which may serve as an mBlog server) and a Mobile Xplorer 1906, which, as referred to above, may be used to manage and administer the system.

A first mobile operator 1908 includes a billing server 1910, a location server 1912, and a delivery platform 1914, all of which are used to provide services to a subscriber base represented by a mobile device 1916. Similarly, a second mobile operator 1918 includes a billing server 1920, a location server 1922, and a delivery platform 1924, which are similarly used to provide services to a separate subscriber base represented by a mobile device 1926.

It should be understood that the delivery platforms 1914 and 1924 may include some or all of the various delivery platforms discussed above, including, for example, iMode, WAP, MMS, and SMS. In particular, the delivery platforms 1914 and 1924 may each implement some separate subset of these platforms, depending on decisions made by the mobile operators 1908 and 1918.

Nonetheless, the architecture of FIG. 19, including features described above with respect to FIGS. 1 and 9, allows the application service provider 1902 to provide mBlog and other services to the subscribers 1916 and 1926, even though these subscribers may be signed up with different operators using different delivery platforms. As a result, friends who happen to use different mobile operators may nonetheless be able to share and view one another's mBlogs and other services provided by the application service provider 1902.

Moreover, the application service provider 1902 may use the location servers 1912 and 1922 to obtain location information for including with mBlog entries, as referred to above. Similarly, the application service provider 1902 may use the billing servers 1910 and 1920 to provide premium services, such as, for example, the subscription services described above.

The various mBlog implementations described herein allow users and service providers of many types of mobile devices to benefit from the advantages of mobile blogging. A number of implementations have been described. Nevertheless, it will be understood that various modifications may be made. Accordingly, other implementations are within the scope of the following claims.

1. A system comprising:
a server operable to receive content over a mobile network from a mobile computing device operated by a first user;
a time-stamping subsystem operable to assign a generation time associated with generation of the content at the mobile computing device; and
a mobile data delivery platform operable to output the content and the generation time over a computer network to a second user.

2. The system of claim 1 comprising a location-stamping subsystem operable to assign location information describing a location of the first user to the content.

3. The system of claim 1 wherein the server receives a request from the second user for time-specified content, and outputs the time-specified content to the second user using the time-stamping subsystem.

4. The system of claim 1 wherein the mobile data delivery platform is operable to deliver the content to a mobile phone of the second user.

5. The system of claim 4 wherein the server is operable to store subscription information for the second user, and is further operable to forward the content to the second user over the mobile phone, based on the subscription information.

6. The system of claim 1 wherein the server is operable to receive secondary content from the second user and associate the secondary content to the content.

7. The system of claim 1 wherein the server is operable to sort and index the content relative to existing content or categories, and is further operable to provide searching of the content based on the sorting and indexing thereof.

8. The system of claim 1 wherein the content includes text, image information, audio information, or numerical information.

9. The system of claim 1 wherein the location-stamping subsystem obtains the location information for the first user from cell positioning information obtained from the mobile network.

10. The system of claim 1 wherein the location-stamping subsystem obtains the location information for the first user using a location based server or a global positioning system.

11. The system of claim 1 wherein the server is operable to permanently store the content.

12. The system of claim 1 wherein the server is further operable to deliver the content to a pre-defined group of recipients, the group including the second user, to receive a comment on the content from the second user, and to modify the content with the comment for re-distribution to the group, including the first user.

13. The system of claim 1 comprising a media server operable to receive a request from the server for a digital image, and further operable to transcode the digital image to an acceptable format for physical printing thereof.

14. The system of claim 1 comprising a database for storing the content, the content including a first collection of digital images or audio and a second collection of digital images or audio, wherein the first collection is associated with a first access level and the second collection is associated with a second access level.

15. The system of claim 1 comprising a remote server that is remote from the server, wherein the server is operable to forward the content to the remote server for distribution to multiple servers at geographically dispersed locations.

16. The system of claim 1 wherein the server is operable to determine that the first user is not a registered user, and is further operable to automatically generate a user profile for the first user, based on information received within the content.

17. The system of claim 1 wherein the server is operable to associate a ratings portion with the content for outputting to the second user, and is further operable to compile rating information received from the second user using the ratings portion with additional rating information previously received from other users.

18. The system of claim 1 comprising a media server operable to transcode digital image information included within the content for display based on a defined type of mobile device being used by the second user as received from the server, wherein the server determines the defined type of mobile device used by the second user based on a request from the second user.

19. The system of claim 1 wherein the server outputs the content to a first service provider associated with the second user for outputting to the second user, and further outputs the content to a second service provider associated with a third user for outputting to the third user.

20. A method comprising:
receiving content entered into a mobile device by a user of the mobile device, via a network on which the mobile device operates;
determining a blog file associated with the user;
including the content within the blog file; and
making the blog file, including the content, available to other users of the network.

21. The method of claim 20 wherein receiving content from the user comprises:
determining location information defining a location of the user at a time the content was entered into the mobile device; and
associating the location information with the content.

22. The method of claim 20 wherein receiving content from the user comprises:
determining time information defining a time at which the user entered the content into the mobile device; and
associating the time information with the content.

23. The method of claim 20 wherein receiving content comprises receiving digital image or audio information.

24. The method of claim 20 wherein making the blog file available comprises:
determining subscribed users from among the other users who have previously requested a subscription to the blog file; and
distributing the blog file to the subscribed users.

25. The method of claim 20 wherein making the blog file available comprises publishing the blog file to the public Internet.

26. The method of claim 20 wherein making the blog file available comprises outputting the blog file to a first and second service provider, wherein the other users include users of the first service provider and users of the second service provider.

27. The method of claim 20 comprising:
receiving a comment from one of the other users in reply to the blog file;
associating the comment with the blog file; and
outputting the blog file, including the comment, to the other users, including the user.
